(19) United States
(12) Patent Application Publication
(10) Pub. No.: US 2009/0297422 A1
(43) Pub. Date: Dec. 3, 2009

(54) Machining nanometer-sized tips from multi-walled nanotubes

(76) Inventors: Jian-Min Zuo, Champaign, IL (US); Ayten Celik Aktas, Urbana, IL (US); James F. Stubbins, Champaign, IL (US); Scott MacLaren, Champaign, IL (US)

Correspondence Address: GREENLEE WINNER AND SULLIVAN P C, 4875 PEARL EAST CIRCLE, SUITE 200, BOULDER, CO, 80301, US

(21) Appl. No.: 11/479,954

(22) Filed: Jun. 30, 2006

Related U.S. Application Data
(60) Provisional application No. 60/695,684, filed on Jun. 30, 2005.

(51) Int. Cl. C01B 21/064; B32B 9/00

(52) U.S. Cl. 423/290; 428/366; 977/773

(57) ABSTRACT

The invention provides sharpened multi-walled nanotubes and methods for sharpening multi-walled nanotubes. The methods of the invention use an electron beam to machine the multi-walled nanotube to the desired dimensions. The invention provides sharpened boron nitride nanotubes where the radius of the end of the sharpened tip is less than about 10 nm.

### CROSS-REFERENCE TO RELATED APPLICATIONS

This application claims the benefit of United States Provisional Application 60/695,684, filed Jun. 30, 2005, which is hereby incorporated by reference to the extent not inconsistent with the disclosure herein.

### ACKNOWLEDGEMENT OF GOVERNMENT SUPPORT

This invention was made with Government support under contract number DEFG02-91-ER45439 awarded by the U.S. Department of Energy (DOE). The United States Government has certain rights in the invention.

### BACKGROUND OF THE INVENTION

This invention relates to multi-walled nanotubes having a sharpened tip and methods for shaping multi-walled nanotubes. The invention relates in particular to boron nitride multi-walled nanotubes.

Nanotube materials can exhibit extraordinary mechanical, electrical and/or chemical properties, which has stimulated substantial interest in developing applied technologies exploiting these properties. For example, nanotubes can have very high Young's modulus values. Multi-walled carbon nanotubes have been measured to have Young's modulus values between 0.1 and 1.33 TPa, with the Young's modulus being dependent upon the degree of order within the tube walls (Demczyk et al., 2002, Mater. Sci. and Engr. 1334, 173-178; Salvetat et al., 1999, Appl. Phys. A 69, 255-260). Multi-walled boron nitride nanotubes have been measured to have a Young's modulus of about 1.22 TPa (Chopra et al., 1998, Solid State Comm, 105(5), 297-300). Because of their high strength nanotubes have been suggested as reinforcements for composite materials.

Nanotubes have also been proposed as probes for sensing and manipulating microscopic environments and structures. For example, both single walled and multi-walled carbon nanotubes have been used as probes for atomic force microscopy (AFM). AFM instruments measure surface topology by dragging a very small probe over the surface being measured. The probe resides on the end of a cantilever. As the probe moves over the surface, the probe follows the contours of the surface, resulting in measurable vertical motion of the cantilever. AFM resolution depends on the physical characteristics of the probe, including the size, shape and rigidity of the probe. In general, a combination of small tip diameter and high length to diameter aspect ratio is favorable. Imaging artifacts can result if a sample has vertical structure comparable with the steepness of the sides of the probing tip. Silicon and silicon nitride probes are commercially available; their shape is pyramidal with a point having a radius of curvature as low as 5 nm (Stevens et al., 2000, Nanotechnology, 11, 1-5). Single-walled carbon nanotubes can be produced with a tip diameter as small as 1 nm, but are susceptible to high background thermal noise. Single-walled carbon nanotubes can also deflect more under loading than a multi-walled carbon nanotube. Sharpened multi-walled carbon nanotubes have been proposed as a way to increase the lateral stability of the probe while providing a small tip diameter (U.S. Published Patent Application Number 2003/0233871).

Nanotubes can also be used as nanomanipulators. For this application, high nanotube stiffness and small tip size are also important. Other proposed uses for sharpened multi-walled nanotubes include field emission tips, electrodes, catalysts, and probes for biological insertion (U.S. Pat. No. 6,709,566).

The patent literature describes several electrical methods for sharpening multi-walled nanotubes. Cumings et al. (U.S. Pat. No. 6,709,566) describes sharpening of one end of a multi-walled nanotube by applying a potential difference between the nanotube and an electrode, the electrode being in actual or proximal contact with the nanotube. The typical applied potential difference is described as being no more than about 10 V. FIGS. 1-4 of Cumings et al. show progressive sharpening of one end of a carbon multi-walled nanotube, with the sharpened radius being about 2.1 to 2.5 nm.

Nguyen et al. (U.S. Patent Application Publication Number 2003/0233871) describes sharpening of one end of a multi-walled carbon nanotube by applying a current between one end of the nanotube and a conducting substrate in contact with the other end of the nanotube. The typical applied potential difference is described as being no more than about 3V.

Nakayama et al. (U.S. Pat. No. 6,777,637) describes a sharpening method which uses current flow through a conductive multi-walled nanotube to cut the nanotube. Each end of the nanotube is connected to an electrode and a voltage is applied between the electrodes to cause flow of current. FIG. 4 of Nakayama et al. shows a taper formed near the cut end of a multi-walled nanotube.

In addition, Martinez et al. report sharpening of the end of a carbon nanotube by applying a 2 V DC voltage across the nanotube while cutting it with an electron beam (Martinez, J. et al., 2005, Nanotechnology, 16, 2493-2496).

Thinning of carbon nanostructures and metal nanowires under electron beam irradiation has been reported in the scientific literature. Troiani et al. report elongation and thinning of carbon fibers under the combined effects of electron beam irradiation and axial strain (Troiani, H. E. et al., 2003, Nano Letters, 3(6), 751-755). The irradiation conditions were reported as 20-40 A/cm². Structural changes in the fibers were reported under these conditions. Banhart et al. report irradiation of multiwalled carbon nanotubes with a 300 kV electron gun at a temperature of 600° C., electron beam diameters of 10-25 nm, and beam current densities of 60-500 nA (Banhart et al., 2005, Physical Review B, 71, 241408). Collapse of the nanotubes into a double cone morphology was illustrated for beam currents of 450 A/cm² and 155-65 A/cm². Li et al. report that irradiation of a multi-walled carbon nanotube resulted in removal of the outer layers and to successive curling of the inner shells until a spherically closed onion-like structure connects the two halves of the nanotube. The electron beam was 300 kV, the nanotubes were held at a temperature of 600° C. in a heating stage and the beam spot size was slightly larger than the diameter of the tube (Li, J. and Banhart, F., 2004, Nanoletters, 4(6), 1143-1146).

Oshima reports thinning of gold and platinum nanowires under electron beam irradiation (Oshima, 2004, JEOL News, 39(2), 44-48). For the platinum nanowires, the electron dose was 20 A/cm² during thinning. For the gold nanowires, the electron dose was either 50 A/cm² or 30 A/cm² during thinning. Structural changes in the metal nanowires were reported under these conditions.

Japanese Publication 2004058194 to Hiroki et al. describes use of an electron beam to cut a carbon nanotube at a arbitrary position, deform a carbon nanotube, join a carbon nanotube and fix a carbon nanotube to another substance. The electron beam conditions for cutting are listed as 7.51×10⁶ A/mm² (7.51×10⁸ A/cm²) to 2.1×10¹⁰ A/mm² (2.1×10¹² A/cm²).

Yuzvinsky et al. report cutting of carbon and boron nitride nanotubes with the focused electron beam of a scanning electron microscope (Yuzvinksky, T. D. et al., 2005, Applied Physics Letters, 86, 053109). It was reported that the most important factor affecting the cutting speed was the presence of water vapor within the chamber.

Previous radiation damage investigations of boron nitride (BN) nanotubes reported undulation and breaking of outermost layers to form irregular cages (Stephan, O., 1998, Applied Physics A, 67, 107-111). For nanotubes with a sufficient number of layers, it was reported that the inner layers were also affected, separating from their neighboring layer, shrinking and breaking into small pieces to form small cages. It was stated that the observations were made in a field emission 300 kV microscope with electron doses 10-20 times higher than under normal imaging conditions.

Han et al. describe formation of boron nitride conical nanotubes synthesized using carbon nanotubes as templates (Han, H. Q. et al., 2000, Applied Physics A: Materials Science and Processing, 71(1), 83-85). The typical dimensions of the BN conical nanotubes are described as 15 nm diameter, 1 nm inner diameter and 40 degrees apex angle.

There remains a need in the art for additional methods for sharpening multi-walled nanotubes, especially methods which are suitable for nanotubes other than carbon nanotubes.

### SUMMARY OF THE INVENTION

In an embodiment, the invention provides sharpened multi-wall nanotubes and methods for their manufacture. Sharpened boron nitride multi-walled nanotubes are especially useful for use as AFM probes and as nanomanipulators because of their high flexural strength. The methods of the invention use an electron beam to machine the nanotube to the desired tip dimensions. The methods of the invention are suitable for use with multi-walled nanotubes having lower electrical conductivity than is obtainable with carbon nanotubes.

The methods of the invention use a nanometer-sized electron beam to sharpen the multi-walled nanotube. During the sharpening process the electron beam is essentially stationary with respect to the nanotube and the beam diameter is at least as large as the outer diameter of the nanotube. Irradiation of the nanotube leads to collapse of the nanotube in the irradiated region forming a region of reduced outer diameter. Continued irradiation of the tube leads to continued thinning and formation of a sharpened tip. The sharpening process of the invention therefore differs from processes in which a smaller diameter electron beam is moved perpendicular to the nanotube longitudinal axis to make a fairly straight cut across the nanotube. Although the sharpening process occurs through irradiation damage of the nanotube, the nanotube remains largely crystalline up to the free end, or apex, of the tip.

In an embodiment, the sharpened boron nitride nanotubes of the invention have a sharpened tip, where the radius of the end of the tip is less than about 10 nm. In another embodiment, the tip end radius is less than about 5 nm.

The dimensions of the unsharpened portion of the nanotube are selected to provide the required resistance to bending. Beam deflection as a function of applied load for a hollow cylindrical beam can be used to estimate the bending response of an unsharpened nanotube. The deflection of a hollow cylindrical beam is inversely proportional to the moment of inertia of the beam, which in turn is proportional to the difference of the outer radius to the fourth power and the inner radius to the fourth power (Salvetat et al., 1999, Appl. Phys. A 69, 255-260). The deflection is also inversely proportional to the Young's modulus. The outer diameter of the unsharpened portion of the nanotube depends on the number of walls in the nanotube. Useful outer diameter values are between about 10 and about 100 nm. In an embodiment, the unsharpened outer diameter is between about 10 and about 50 nm.

In an embodiment, the ratio of the length of the sharpened portion of the tube to the outer diameter of the unsharpened tube is between about 0.5 and about 3. The nanotube structure in the sharpened region is multi-walled up to the end of the sharpened tip or to near the end of the sharpened tip.

The beam conditions are selected so that the entire sharpened tip region is not amorphous, including the end of the tip. The nanotube has a multi-wall structure up to near the end of the tip. In an embodiment, the electron dose for boron nitride is between about 30 A/cm² and about 3×10⁶ A/cm² for 200 keV electrons. The sharpening methods of the invention are compatible with materials which do not become amorphous under the irradiation conditions. These materials include, but are not limited to, boron nitride.

In an embodiment, the invention provides a method for sharpening a multi-walled nanotube comprising the steps of:
a) providing a multi-walled nanotube under vacuum;
b) positioning an electron beam on the nanotube, wherein the diameter of the beam is at least as large as the outer diameter of the nanotube; and
c) exposing the nanotube to the electron beam for sufficient time to form a sharpened tip region on the nanotube, the sharpened tip region having a free end,
   wherein the nanotube material is selected from the group consisting of III-V compounds, carbon nitride, carbon boron nitride, oxides and sulfides and the tip structure is not amorphous. In an embodiment, the tip structure is multiwalled up to 5 nm or less from the free end. The size of the electron beam relative to the diameter of the nanotube can be used to control the tip shape.

The invention also provides multiwalled nanotubes having a sharpened tip region and an unsharpened region. The structure of the sharpened region is not amorphous. In an embodiment, the structure of the sharpened region is multiwalled up to 5 nm or less from the free end.

### BRIEF DESCRIPTION OF THE FIGURES

FIG. 1A: Transmission electron microscope (TEM) image of multi-walled boron nitride nanotube before sharpening.

FIG. 1B: TEM image of the multi-walled boron nitride nanotube of FIG. 1A after irradiation with a 90 nm diameter 200 keV electron beam.

FIG. 1C: TEM image of the multi-walled boron nitride nanotube of FIG. 1A after irradiation with a 50 nm diameter 200 keV electron beam at position 2 and a 5 nm diameter 200 keV electron beam at position 3.

FIG. 2A: High-resolution transmission electron microscopy image of a multi-walled boron nitride nanotube before sharpening.

FIG. 2B: TEM image of the nanotube of FIG. 2A after 18 minutes of irradiation at 300 A/cm².

FIG. 2C: TEM image of the nanotube of FIG. 2A after 25 minutes of irradiation at 300 A/cm².

FIG. 2D: High resolution TEM image of one of the tips from FIG. 2C, showing the layered structure of the tip.

FIG. 3: High-resolution transmission electron microscopy image of a multi-walled boron nitride nanotube after sharpening with an electron beam whose diameter was approximately the same as the nanotube diameter.

FIG. 4: Transmission electron microscopy image of a multi-walled boron nitride nanotube after sharpening with an electron beam whose diameter was several times the nanotube diameter. The nanotube sample holder was cooled during the sharpening process.

### DETAILED DESCRIPTION OF THE INVENTION

As used herein, the term “nanotube” refers to a tube-shaped discrete fibril typically characterized by a substantially constant diameter of typically about 1 nm to about 100 nm, preferably about 2 nm to about 50 nm. In addition, the nanotube typically exhibits a length greater than about 10 times the diameter, preferably greater than about 100 times the diameter. The term “multi-wall” as used to describe nanotubes refers to nanotubes having a layered structure, so that the nanotube comprises an outer region of multiple continuous layers of ordered atoms and an optional distinct inner core region or lumen. The layers are disposed substantially concentrically about the longitudinal axis of the fibril. A variety of multi-walled nanotube compositions are known to the art, including, but not limited to, carbon, boron nitride and other III-V compositions, carbon nitride, carbon boron nitride, oxides, and sulfides. As is known in the art, III-V compounds combine elements from groups III and V of the periodic table.

Boron nitride nanotubes comprise boron combined with nitrogen. In an embodiment, the nanotubes comprise essentially only boron and nitrogen. Boron nitride nanotubes may contain low levels of impurities or can be doped with other elements or molecules. Examples of doping elements include carbon, aluminum, silicon, phosphorous, beryllium, oxygen, and any of the alkali atoms. Hydrogen can be present with Be or Mg doping. Examples of doping molecules are methyl or butyl groups and osmium tetroxide. There are several other possible elements and compounds that will be readily known by those skilled in the art. Typically the concentration of dopants is less than 1%. Besides doping, nitrogen vacancies are also possible in boron nitride. Boron nitride nanotubes can be made by a variety of methods including arc discharge, laser heating, and oven heating. Boron nitride nanotubes have been reported to be a good dielectric material up to about 10V (Cumings, J. and Zettl, A., 2004, Solid State Communications. 129, 661-664).

Other multi-element nanotubes in which the bonding has some ionic character are believed to undergo a similar response to electron irradiation as boron nitride. Nanotube compositions suitable for use with the present invention include other III-V compounds, carbon nitride, carbon boron nitride, oxides, and sulfides. Other III-V nanotubes include, but are not necessarily limited to, GaN and AlN. Oxide nanotubes include, but are not limited to, titanium oxides ( e.g. TiO₂) and vanadium oxides (e.g. V₂O₅). Sulfide nanotubes include, but are not limited to molybdenum sulfides (e.g. MoS₂) and tungsten sulfides (e.g. WS₂).

In an embodiment, the invention provides sharpened nanotubes of III-V compounds, carbon nitride, carbon boron nitride, oxides, and sulfides. In other embodiments, the invention provides sharpened nanotubes of boron nitride and carbon boron nitride or of boron nitride.

As used herein, “sharpening” a nanotube involves shaping the nanotube by removal of nanotube material to form a tapered sharpened tip region. Some of the nanotube walls may also be bent during the sharpening process. The term “tip” as used herein refers to a pointed end. The diameter of the nanotube in the tip region is less than the original nanotube diameter. The tip of the nanotube tapers from its free end or apex to its base. The varying cross-sectional area can be achieved by varying the number of layers about the longitudinal axis of the nanotube. The unsharpened region of the nanotube retains its original outer diameter.

As used herein, the end of the tip is the free end of the tip or the tip apex. In an embodiment, the end of the tip is approximately circular in cross-sectional area and may be characterized by its diameter or radius. The measurement of a tip's radius of curvature can be achieved by fitting a circle within the apex within a TEM image of the tip and measuring the radius directly.

In the methods of the invention, the nanotubes retain a multiwalled structure up to near the tip apex. If the tip is very sharp, the end of the tip may be a single-walled nanotube. The single-walled portion can be up to 5 nm long, but is typically up to 2-3 nm long. At and near the tip apex, the walls of the nanotube may terminate in nanoarches formed by joining of nanotube layers. Typically, a nanoarch will form across the inner diameter of the nanotube, capping it. The nanotube structure remains largely crystalline up to the tip apex. By largely crystalline, it is meant that distinct nanotube walls are visible with the transmission electron microscope.

The tip may also be characterized by the included angle or cone angle defined by the tapered surface of the tip. The cone angle may vary along the tip length. The cone angle may be determined near the tip apex or at a specified distance from the tip apex. At a specified distance from the tip apex, the cone angle may be estimated as twice the angle whose tangent is half the tip width at the specified distance divided by the specified distance.

The length of the tip is the distance between the end of the tip and the start of the unsharpened region. The length of the nanotube may be reduced during the sharpening process. If the electron beam is positioned sufficiently far away from the ends of the nanotube, the electron beam may cut the nanotube in two, forming a sharpened region on both pieces of the nanotube.

In the methods of the invention, an electron beam is positioned on the nanotube. In other words, the beam is positioned so that electrons in the beam contact the nanotube. In an embodiment, the beam is approximately centered on the nanotube. In an embodiment, the longitudinal axis of the beam is substantially normal to the longitudinal axis of the nanotube. The diameter of the beam is at least as large as the outer diameter of the tube.

In the methods of the invention, the electron beam has a sufficiently high voltage that irradiation of the nanotube with the electron beam results in collapse of the nanotube and bending of the nanotube walls to form a region having an outer diameter less than the diameter of the unirradiated portion of the tube. In an embodiment, the nanotube does not completely collapse to the extent that the inner diameter of the tube is completely eliminated. This reduced diameter region subsequently reduces further in diameter to form the sharpened tip. If sharpening takes place sufficiently far away from the free end of the nanotube, the reduced diameter region may form a “neck” between the unirradiated areas. Subsequent irradiation of the neck results in the formation of two sharpened tips. For boron nitride nanotubes, peeling of the nanotube layers is observed at both the outer and inner surfaces of the nanotube and is believed to cause the tube wall collapse (see Example 2).

Typically, both the beam and the nanotube are under vacuum and located in a vacuum chamber which is evacuated to less than atmospheric pressure. The vacuum level in the chamber should be sufficiently high that contamination (e.g. carbon contamination) does not limit the sharpening process. In an embodiment, the vacuum level in the chamber is between 1×10⁻⁶ torr and 1×10⁻⁹ torr. However, higher vacuum levels, such as the 1×10⁻¹¹ torr available in a TEM, are also suitable for use with the invention. It is not required that a significant amount of water vapor be present within the vacuum chamber.

In an embodiment, the electron beam is provided by a transmission electron microscope, scanning electron microscope or scanning transmission electron microscope. In an embodiment, the electron beam is provided by a field emission electron microscope. If the electron beam is provided by a transmission electron microscope, the microscope can be used to simultaneously monitor the sharpening process. In other embodiment, the electron beam is provided by a scanning electron microscope. Typical scanning electron microscopes provide beam acceleration voltages on the order of 30 keV, but custom instruments are capable of beam acceleration voltages up to 80-100 keV. In this embodiment, the beam is stationary during sharpening, but sharpening can be stopped or completed and the beam can be scanned to image the nanotube. The ability to monitor the sharpening process aids in parameter adjustment during the process. For example, it may be desirable to adjust the intensity of the electron beam during the process. The electron beam can be controlled by using the condenser lens. The electron beam size is varied by changing the convergence angle. The beam current can be adjusted by changing or removing the condenser aperture.

Typically, a plurality of multi-walled nanotubes is provided on a suitable sample holder and the imaging capabilities of the microscope are used to position the electron beam on a particular nanotube. The nanotubes may be attached to the sample holder by any method known to the art. Preferably, the nanotube selected for sharpening is substantially straight, rather than curved. If the nanotubes on the sample holder have a range of diameters, the nanotube may also be selected for sharpening on the basis of the desired diameter of the sharpened nanotube. The position of the electron beam on the nanotube is selected so as to provide a sharpened nanotube of the desired length. When the sharpened nanotube is to be used as an AFM probe, the sample holder may be a base suitable for use in an AFM.

The sharpening process does not require that the nanotube be cooled or that additional heat be supplied to the nanotube during electron beam irradiation; i.e. the nanotube may be irradiated at ambient temperature. In an embodiment, the nanotube is irradiated at ambient temperature or below ambient temperature. In another embodiment, the temperature of the sample holder is controlled during the sharpening process, thereby controlling the temperature of at least a portion of the nanotube. In an embodiment, the sample holder is cooled below ambient temperature. In an embodiment, the sample holder is liquid nitrogen cooled to approximately 104 K. Methods for temperature control of sample holders are known to those skilled in the art of electron microscopy.

The nanotube is exposed to the electron beam for a sufficient time to form a sharpened region on the nanotube. The time required depends in part on the electron beam intensity and voltage. In different embodiments, the voltage range is between 80 keV and 1 MeV, between 80 and 200 keV, between 100 keV and 300 keV, greater than or equal to 50 keV, greater than or equal to 80 keV, or greater than or equal to 150 keV. Microscopes operating at voltages greater than 1 MeV up to 3 Mev can also be suitable for use with the invention. In different embodiments, the sharpening time is less than about two hours, less than about one and one-half hours, less than about one hour and less than about one-half hour. The electron beam intensity is selected to be sufficiently low that the sharpened region displays a multi-walled structure up to the free end of the tip. The presence of a multi-walled structure in most of the sharpened region is expected to give the sharpened nanotube better resistance to bending and fracture than if the structure were single-walled or amorphous. The structure of the end of the tip may be multi-walled or not. For boron nitride multi-walled nanotubes, the electron beam intensity is greater than about 1×10⁶ electrons/nm²sec (approximately 16 A/cm²).

The electron beam intensity depends on the electron beam size. The size of the electron beam when it contacts the nanotube is selected to provide the desired shape in the sharpened region. This beam size can be adjusted by changing the illumination lens setting of the microscope. For a given beam accelerating voltage and nanotube material and size, smaller beam diameters result in shorter sharpened region lengths and larger sharpened tip radii. When the beam diameter becomes small enough, the tip becomes blunt. When the beam diameter becomes large enough, the beam intensity is low and the sharpening process becomes very slow. Because sharper tips are obtained with longer sharpened regions, the sharpness of the tip may be practically limited by flexural strength requirements for the sharpened region. In an embodiment, the beam intensity is between about 30 A/cm² and about 3×10⁶ A/cm². In other embodiments, the beam intensity is between 150 A/cm² and about 3000 A/cm² and between 300 A/cm² and about 1500 A/cm².

In an embodiment, the beam diameter is nanosized. As used herein, a nanosized beam diameter is greater than one nanometer and less than one micron. In different embodiments, the beam diameter when it contacts the nanotube is about one to about five times the diameter of the unsharpened nanotube, about 1.5 to about 3.5 times the unsharpened nanotube diameter, and about two to about three times the unsharpened nanotube diameter. The beam diameter influences the length of the sharpened region, with increasing beam diameter resulting in a longer sharpened region.

The sharpening process may be a multi-stage process, with different beam diameters being used in different stages. For example, a first beam diameter may be used in a first stage and a second beam diameter in a second stage.

The sharpening process may also be followed by a cutting process (in which the beam diameter is less than the nanotube outer diameter (o.d.)). For example, the nanotube may exposed to the larger diameter electron beam for sufficient time to form a necked region of the desired minimum outer diameter and then the necked region cut by moving the smaller diameter beam across the nanotube.

In different embodiments, the ratio of the length of the sharpened region to the unsharpened nanotube diameter is between about 0.5 and about 5, between about 0.5 and about 10, and about 0.5 and about 20, and between about 0.5 and about 30. In different embodiments, the sharpened nanotubes of the invention have a tip end radius less than about 20 nm, less than about 10 nm, or less than about 5 nm.

More generally, the invention provides a method for shaping a multi-walled nanotube comprising the steps of: providing a multi-walled nanotube under vacuum, positioning an electron beam on the nanotube, and exposing the nanotube to the electron beam, thereby shaping the nanotube by selective removal of a portion of the nanotube.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

Whenever a range is given in the specification, for example, an electron dosage range or a time range, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

One skilled in the art would readily appreciate that the present invention is well adapted to carry out the objects and obtain the ends and advantages mentioned, as well as those inherent therein. The methods and accessory methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

All references cited herein are hereby incorporated by reference to the extent that there is no inconsistency with the disclosure of this specification.

### EXAMPLE 1

### Shaping Of Boron Nitride Nanotubes

The boron nitride nanotubes were synthesized by a carbon-free chemical deposition process at 1373 K. (Tang, C. et al., 2002, Chemical Communications, 12, 1290-1291). The tube outer diameters range from 12 to 80 nm and the inner diameters ranges from 3 to 18 nm. There was some variation in the outer diameter and inner diameter of the tube along the length of the tube.

For irradiation studies, the samples were prepared by depositing boron nitride nanotubes from a dispersion of nanotubes in acetone onto copper grids covered with holey carbon film and allowing the solvent to evaporate. Electron beam irradiation and transmission electron microscope studies were carried out with a JEOL 201 OF EF-FEG TEM at a high voltage of 200 keV. The electron beam was controlled using the condenser lens. The electron beam size was varied by changing the convergence angle. The smallest beam that could be achieved this was using a 120 micron condenser aperture is about 5 Angstroms (half width at half maximum). For this microscope, a beam diameter of 300 nm gave a dose of 30 A/cm² and a beam diameter of about 1 nm gave a dose of about 3×10⁶ A/cm².

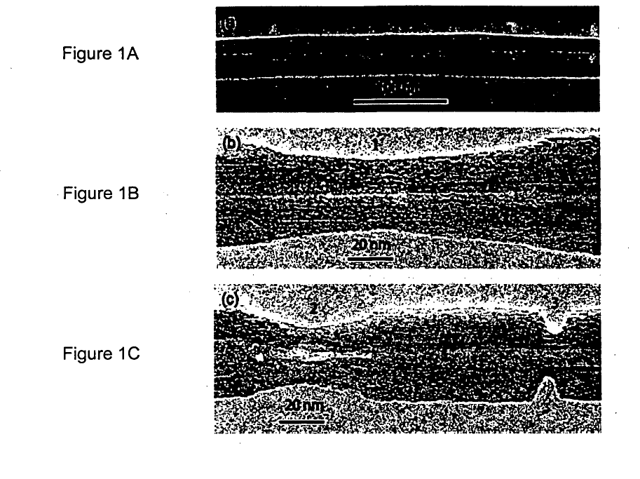

The effects of electron beam irradiation on a multiwalled BN nanotube (outer diameter approximately 43 nm, inner diameter approximately 11 nm) are displayed in FIGS. 1A-1C, which shows the nanotube before (FIG. 1A) and after the exposure to three different beam sizes: size 1 of 90 nm (FIG. 1B), size 2 of 50 nm (FIG. 1C) and size 3 of 5 nm in diameter (FIG. 1C). Electron beam cutting was achieved with the 5 nm beam. At this beam size the electron beam was highly convergent and the electron beam dosage was 1.45×10⁵ A/cm². At beam sizes 1 and 2, the nanotube partially collapses under the electron beam and forms a necked region. The length of the necked region depended on the electron beam size and was 90 nm at size 1 and 50 nm at size 2. The collapsed neck was approximately circular in cross section. Projection images at two viewing angles of 24 degrees apart of another electron beam damaged nanotube show the same diameter. This suggests that the damage was isotropic around the circumference of the nanotube when the beam size is as large as the outer diameter of the nanotube.

### EXAMPLE 2

### Sharpening of Boron Nitride Nanotubes

The nanotubes and electron beam source were as generally described in Example 1. Boron nitride nanotubes were attached to a TEM sample holder so that the nanotubes were suspended in vacuum and at least one end of each tube was supported.

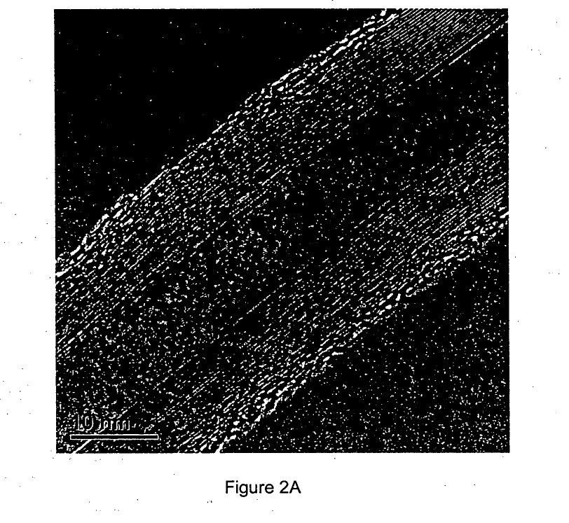

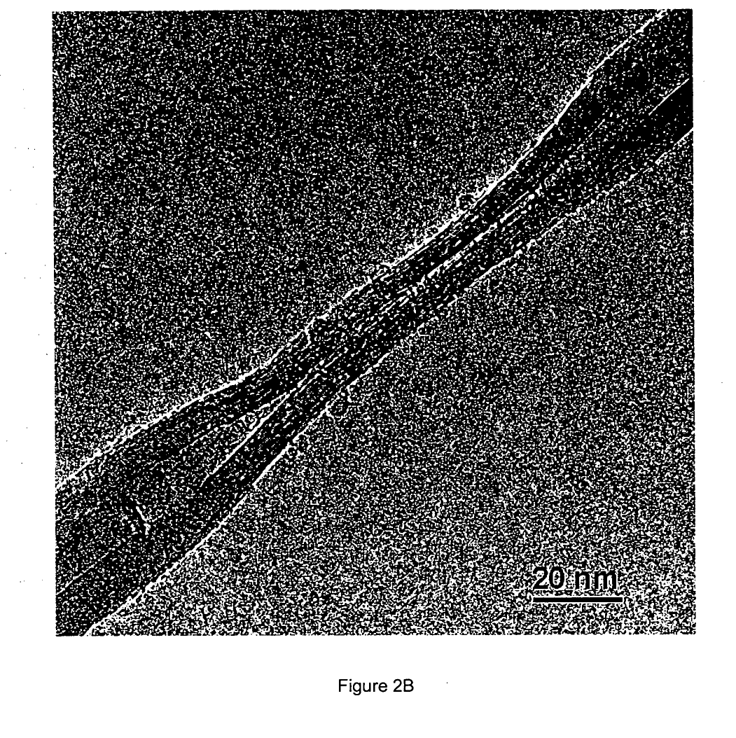

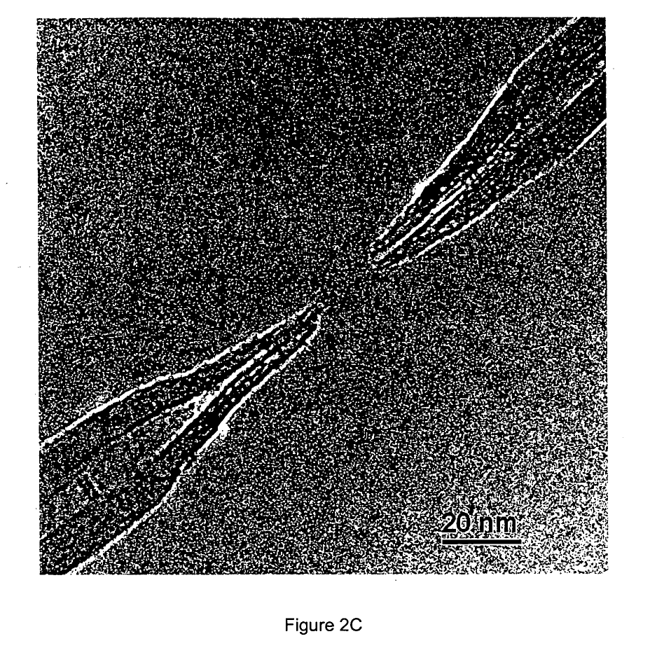

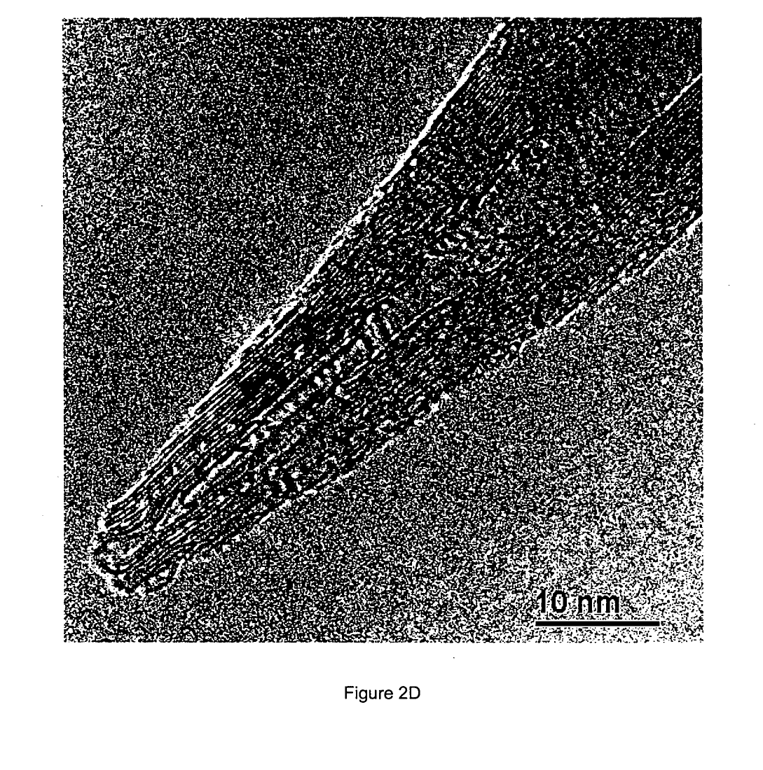

FIGS. 2B-2D show TEM images taken at various stages of irradiation of a BN nanotube which has an outer diameter of 27 nm and inner diameter of 9 nm. The BN nanotube was at ambient temperature during irradiation (no cooling or additional heating was applied). The electron beam was 110 nm with an electron dosage of 300 A/cm² during irradiation. FIG. 2A shows the tube prior to irradiation.

The images in FIGS. 2B and 2C show that the irradiation resulted in collapse of the inner walls accompanied with a decrease in the wall thickness. From FIG. 2B, despite the collapse of the inner diameter of the tube the number of concentric tubes has decreased by only 30%. High resolution electron microscopy images show that the layer peeling occurs at both the outer and inner surfaces of the BN nanotube.

FIG. 2C shows the final stage of irradiation with the tube being broken in two and the formation of sharpened tips at each end. The shaped tip diameters were 10 and 13 nm, measured at the mid-height of the cones. The diameter of the tip end is approximately 5 nm. The length of the tips measured from the undamaged part of the nanotube to the free end of the tips was about 50 nm. Aggregation of material was observed on both inner and outer surfaces of the nanotube suggesting material loss from both inner and outer surfaces. The crystalline nature of the tube appeared to be preserved (FIG. 2D, high resolution image of one of the tips of FIG. 2C). The sharpened region, including the tip, retains the graphite-like hexagonal Boron Nitride structure. The sharpened region is multi-walled up to but not including the very end of the tip.

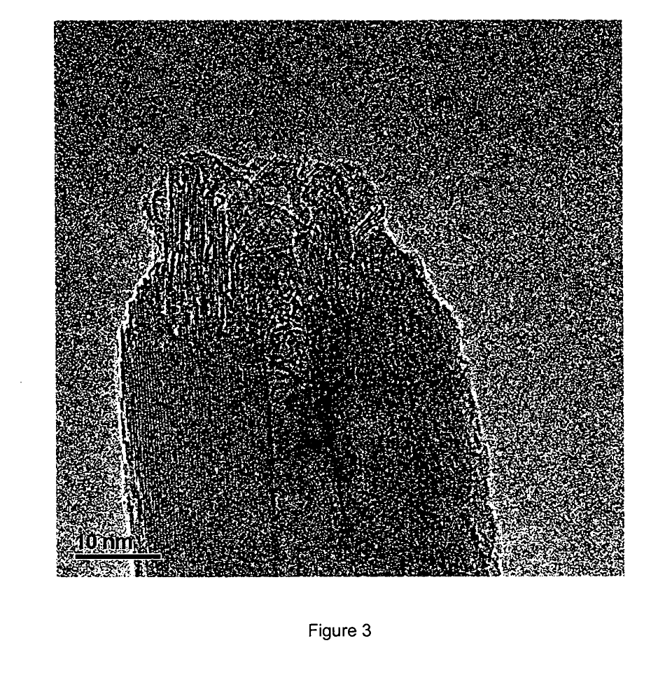

FIG. 3 shows the result obtained when an approximately 40 nm outer diameter (o.d.) boron nitride nanotube was exposed to an electron beam having a current density of 2100 A/cm² and a beam diameter of approximately 40 nm for approximately 15 minutes. The tip length is significantly shorter than that in FIG. 2C, approximately 20 nm. The diameter of the tip end is significantly greater, approximately 22 nm. The sample holder was not cooled during either sharpening procedure.

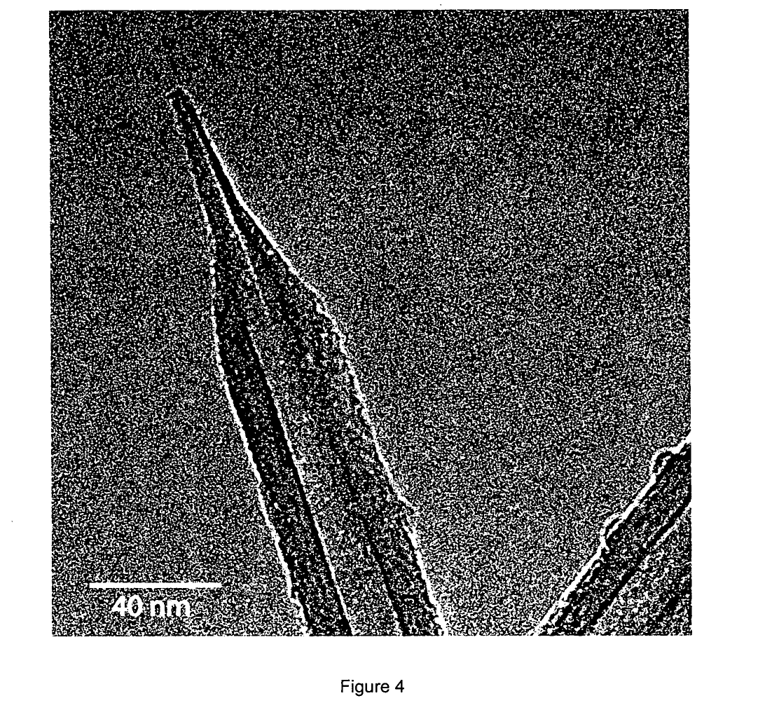

FIG. 4 shows the result obtained when an approximately 45 nm o.d. boron nitride nanotube was exposed to an electron beam having a current density of 350 A/cm² and a beam diameter of approximately 100 nm for approximately 40 minutes while the sample was cooled to −175 degrees C. The diameter of the tip end is approximately 3 nm. The total tip length is approximately 72 nm. In addition, the taper angle or included angle is smaller near the free end of the tip than it is near the other end. The taper angle is the angle between opposing planes tangent to the outer wall of the nanotube. The section with a smaller taper angle is approximately 42 nm long.

Another boron nitride nanotube, approximately 42 nm in diameter, was exposed to an electron beam having a current density of approximately 250 A/cm² and a beam diameter of approximately 120 nm for about 80 minutes. The sample holder was heated to 750 degrees C. The approximate diameter of the end of the tip was 13 nm and the tip length was approximately 73 nm long. Particles formed on the tube, which may have been due to contamination.

To characterize the tube structure evolution during electron beam irradiation, electron diffraction patterns were recorded from the irradiated areas using nanoarea electron diffraction techniques. The BN nanotube had an outer diameter of 50 nm and an inner diameter of 12 nm. The nanotube was at ambient temperature during irradiation. The electron beam diameter was 120 nm, and the beam dose 250 A/cm².

Prior to irradiation, the diffraction pattern consisted of multiple layer lines associated with the hexagonal lattice of BN and the tube structure; the layer lines were perpendicular to the tube direction. The layer line features were still visible in the diffraction pattern after 70 minutes of irradiation. However, the lines fanned out in X-like shapes, which were associated with the tube wall collapsing and the formation of necked regions. For example, broadening of the (0,0,2n) spots at 70 minutes was due to a change in the relative orientation of (0,0,2n) planes, which changed from zero degrees in the t=0 case to +/−10 degrees at 70 minutes. The overall diffraction intensity also decreased by 40%. Since the diffraction intensity is proportional to degree of order and the amount of material present in the volume under investigation, decreasing diffraction intensity is a direct evidence of disordering and material loss during electron beam irradiation.

### EXAMPLE 3

### Cutting of BN Nanotubes

The nanotubes and electron beam source were as generally described in Example 1.

A BN nanotube having an outer diameter of approximately 43 nm was exposed to a focused electron beam 3 nm in diameter which was moved across the tube so that only a section of the tube was exposed to the electron beam at each time. The electron density in the focused beam was 4.03×10⁵ A/cm²

The electron beam irradiation resulted in formation of a straight cut approximately perpendicular to the longitudinal axis of the nanotube, rather than a sharp tip. Nanoarches were observed along the cut surface.

We claim:

1. A method for sharpening a multi-walled nanotube comprising the steps of:
a) providing a multi-walled nanotube under vacuum;
b) positioning an electron beam on the nanotube, wherein the diameter of the beam is at least as large as the outer diameter of the nanotube; and
c) exposing the nanotube to the electron beam for sufficient time to form a sharpened tip region on the nanotube, the sharpened tip region having a free end,
wherein the nanotube material is selected from the group consisting of III-V compounds, carbon nitride, carbon boron nitride, oxides and sulfides and the tip structure is multiwalled up to 5 nm or less from the free end.

2. The method of claim 1 wherein the nanotube material is selected from the group consisting of boron nitride and carbon boron nitride.

3. The method of claim 2 wherein the nanotube material is boron nitride.

4. The method of claim 1, wherein the diameter of the electron beam is between 1 and 5 times the diameter of the nanotube when it contacts the nanotube.

5. The method of claim 1, wherein the diameter of the electron beam is between 2 and 3 times the diameter of the nanotube when it contacts the nanotube.

6. The method of claim 1, wherein the voltage of the electron beam is between about 80 kV and about 1 MeV.

7. The method of claim 1, wherein during tip formation, the intensity of the electron beam is between 30 A/cm² and 3×10^{6 A/cm}².

8. The method of claim 7, wherein during tip formation the intensity of the electron beam is between 150 A/cm² and about 3000 A/cm².

9. The method of claim 8, wherein during tip formation, the intensity of the electron beam is between 300 A/cm² and 1500 A/cm².

10. The method of claim 1, wherein the electron beam is provided by a transmission electron microscope.

11. The method of claim 1, wherein the electron beam is provided by a scanning electron microscope.

12. The method of claim 1, further comprising the step of monitoring formation of the sharpened tip.

13. The method of claim 1, wherein during exposure of the nanotube to the electron beam the temperature of at least part of the nanotube is controlled.

14. The method of claim 13, wherein the nanotube is cooled during irradiation.

15. The method of claim 1, wherein the nanotube is attached to a base suitable for use in an atomic force microscope prior to exposure to the electron beam.

16. A multiwalled boron nitride nanotube having an inner diameter and having a sharpened tip region and an unsharpened region, wherein the nanotube walls in the sharpened tip region bend such that the inner diameter of the nanotube in the sharpened tip region is less than the inner diameter of the nanotube in the unsharpened region.

17. The nanotube of claim 16, wherein the sharpened tip end radius is less than about 10 nanometers.

18. The nanotube of claim 16, wherein the sharpened tip end radius is less than about 5 nanometers.

19. The nanotube of claim 16, wherein the ratio of the length of the tip to the outer diameter of the nanotube in the unsharpened region is between about 0.5 and about 10.

20. The nanotube of claim 16, attached to a base suitable for use in an atomic force microscope.

21. A sharpened multi-walled boron nitride nanotube made by the process of claim 1, the nanotube having an inner diameter, a sharpened tip region and an unsharpened region wherein the nanotube walls in the sharpened tip region bend such that the inner diameter of the nanotube in the sharpened tip region is less than the inner diameter of the nanotube in the unsharpened region.

22. The nanotube of claim 21, wherein the sharpened tip end radius is less than about 10 nanometers.

23. The nanotube of claim 22, wherein the sharpened tip end radius is less than about 5 nanometers.

24. The nanotube of claim 21, wherein the ratio of the length of the sharpened tip to the outer diameter of the nanotube in the unsharpened region is between about 0.5 and about 10.

25. The nanotube of claim 21, attached to a base suitable for use in an atomic force microscope.

26. The method of claim 1, wherein the nanotube has an inner diameter, and the step of exposing the nanotube to the electron beam results in bending of the nanotube walls in the sharpened tip region such that the inner diameter of the nanotube in the sharpened tip region is less than the inner diameter of the nanotube in the unsharpened region.

27. The method of claim 1, the electron beam and the nanotube each having a longitudinal axis, wherein the longitudinal axis of the electron beam is substantially normal to the longitudinal axis of the nanotube.

28 The method of claim 1, wherein no additional heat is supplied to the nanotube during the step of exposing the nanotube to the electron beam.
